(19) United States
(12) Patent Application Publication
(10) Pub. No.: US 2023/0122144 A1
(43) Pub. Date: Apr. 20, 2023

(54) System to Identify and Isolate Selected Crustaceans Using Flipping Device to View Ventral Surface

(71) Applicant: Douglas D. BACON, Palo Alto, CA (US)

(72) Inventor: Douglas D. BACON, Palo Alto, CA (US)

(21) Appl. No.: 17/903,656

(22) Filed: Sep. 6, 2022

Related U.S. Application Data
(60) Provisional application No. 63/257,068, filed on Oct. 18, 2021.

(51) Int. Cl. A01K 61/90; G06T 7/00; G06T 7/90; G06V 10/764; G06V 10/82; G01N 21/956

(52) U.S. Cl. CPC A01K 61/90; G06T 7/0004; G06T 7/90; G06V 10/764; G06V 10/82; G01N 21/956; G06T 2207/10016; G06T 2207/10024; G06T 2207/20081; G06T 2207/30128

(57) ABSTRACT

A system and method to determine whether a crustacean meets a selected criterion such as whether a crab is in pre-molt condition. The crustacean is flipped by passing it through a substantially “U” shaped tube. An image is obtained while the crustacean is inverted, and automated image analysis techniques are utilized to make the determination so that the crustacean can be diverted appropriately.

### CROSS-REFERENCE TO RELATED APPLICATION

This application claims priority to U.S. Provisional Application No. 63/257,068 filed on 18 Oct. 2021. The entire contents of the above-mentioned application are incorporated herein by reference as if set forth herein in entirety.

### FIELD OF THE INVENTION

This invention relates to identifying and separating out selected crustaceans such as pre-molt crabs using computerized analysis of camera images and more particularly relates to mechanically flipping the crustacean to reveal characteristics on the ventral side of the crustacean to automatically classify and divert the crustacean into an appropriate receptacle.

### BACKGROUND OF THE INVENTION

Some types of crustaceans such as certain species of crab are much more valuable in the soft-shell form that they take immediately following molting than they are in their typical hard-shell form. Other crustaceans such as the American lobster (Homarus americanus) are perceived to be less desirable when its tissue is filled with water prior to molting.

An example of commercially valuable soft-shell crab is the green crab (Carcinus maenas). A fishery in Italy harvests and processes green crab to produce what they call “Moleche”. These are soft-shell crabs that are typically fried and eaten whole. Raw Moleche has sold for between $20 and $40 a pound.

This same type of crab is also common in the Gulf of Maine where it is considered an invasive pest that consumes valuable shellfish like soft-shell “steamer” clams. A method to automate production of soft-shell green crabs would help enable a fishery for this species on the Atlantic coast. This could create new opportunities for fishers while helping to reduce the harm that this crab causes to commercial shellfish.

It is difficult to catch or trap crabs that are in soft-shell form because they are hiding. A few days before the molt they stop eating and find a hole that they can use for protection when their shell is soft. Therefore, it is necessary to catch them while they are still out feeding but just starting to show signs of an upcoming molt.

In the standard process to produce soft-shell green crabs, the crabs that are in a pre-molt condition are separated via manual sorting and then kept in enclosures until they go through the molting process. The soft-shell crabs that emerge during molting are identified and removed from the water withing a few hours after molting to be prepared for sale. In the case of green crabs, the primary visible signs used to identify the pre-molt condition are on the ventral thorax (bottom) of the animal. This is different from blue crabs where the pre-molt signs are on the back swimming fins.

The manual method of sorting the crabs is slow and requires relevant expertise that is not common in North America. An automated system is needed that can perform this sorting task in order to handle commercially viable amounts of crab.

### SUMMARY OF THE INVENTION

An object of the present invention is to enhance processing of selected live crustaceans according to a selected criterion such as pre-molt condition.

Another object is to determine at least one classification from an image of the underside of the crustacean.

Yet another object of the present invention is to divert the crustacean into an appropriate bin based on the classification.

Another object of the present invention is to process crustaceans at an enhanced rate in a cost-effective manner.

Another object of the invention is to accommodate apparatus being splashed with salt water during use.

This invention features a system to classify and manipulate a selected species of crustacean based on at least one selected characteristic visible on a ventral side of the crustacean. The system includes a curved chute selected to have an inner diameter at least as large as an average maximum dimension of the selected species, the chute defining an opening to receive at least one crustacean at a time, and the chute having a curvature of a curvature section sufficient to invert the crustacean to orient upwardly a ventral surface of the crustacean before the crustacean exits the curvature section at a chute exit. A hollow structure is connected to the chute exit and defines an imaging aperture in an upper wall of the hollow structure. An imaging apparatus having an optical view directable through the imaging aperture images each crustacean passing through the hollow structure. A computer is informationally connected to the imaging apparatus and configured to execute a program to determine, for each imaged crustacean, whether the visible characteristic is present in that imaged crustacean, to assign a first classification to that imaged crustacean based on presence or absence of the visible characteristic, and to instruct a diverter mechanism to direct crustaceans having the first classification to a different location than crustaceans lacking the classification.

In some embodiments, the curved chute is configured to invert each crustacean without physically injuring the crustaceans. In certain embodiments, the system further includes further includes the diverter mechanism, and wherein the diverter mechanism utilizes pressurized fluid such as pressurized air or seawater to divert selected crustaceans without physically injuring the crustaceans. In another embodiment, the selected crustaceans are diverted utilizing mechanical pushing elements such as paddles or flippers. In yet another embodiment, the selected crustaceans are diverted using a slide that tilts one way or the other way.

In a number of embodiments, the imaging apparatus includes at least one camera and at least one source of illumination. In one embodiment, at least one of the curved chute and/or the hollow structure is tubular in cross-section. In another embodiment, the curved chute and the hollow structure are monolithic. In some embodiments, at least the curved chute has a low-friction interior surface which does not noticeably impede travel of each crustacean over the interior surface.

In one embodiment, the selected species is a type of crab and the curved chute is selected to have an inner diameter at least as large as an average width of a carapace of that species of crab. In some embodiments, the computer utilizes a machine learning algorithm to determine presence or absence of the first classification per crustacean. In other embodiments, the first classification is based on at least one of gender, size and/or color of the selected crustacean. In one embodiment, presence of each crustacean traveling past the imaging aperture is detected from camera images without need for an additional trigger sensor. In another embodiment, the system further includes an inlet for a stream of water to assist transit of the crustacean and to physically move debris through at least the hollow structure.

In some embodiments the incoming crab is placed on a table and fed into the input chute manually. In one embodiment, the incoming crab is deposited into a hopper and fed into the input chute with an automated device.

In some embodiments the flipped crab is placed on a conveyor at the output of the flipping tube. In one embodiment, a strobed light is used to freeze the motion of the crab. In other embodiments, a steady bright light and short camera exposure is used to freeze the motion of the crab.

In some embodiments light diffusers are used to create even illumination. In certain embodiments, LEDs are used as the light sources. In one embodiment, a bell-shaped reflector with a matte white surface is used to create even illumination. In another embodiment, one or more polarizing filters are used to reduce glare.

In some embodiments, the system is installed in a boat so that everything other than the pre-molt crabs can be returned to the ocean. In another embodiment, the system is installed in truck so that the classifying and manipulating such as sorting can be performed at the dock. Alternatively, the system is installed in a crab shedding facility to check incoming product.

In some embodiments the system will determine and record the sex and size of the crab. In some embodiments there will be more than two categories for the diverter.

In some embodiments, an inference of classification is implemented as a convolutional neural net (CNN). In yet other embodiments, the inference is implemented as a support vector machine (SVM). In some embodiments the inference is implemented optimized explicit computer code. In some embodiments, a Graphical Processing Unit (GPU) is used to accelerate the inference. In some embodiments a Tensorflow Processing Unit (TPU) is used to accelerate the inference.

This invention also features a method to classify and manipulate a selected species of crustacean based on at least one selected characteristic visible on a ventral side of the crustacean. The method includes selecting a curved chute having an inner diameter at least as large as an average maximum dimension of the selected species, the chute defining an opening to receive at least one crustacean at a time, and the chute having a curvature of a curvature section sufficient to invert the crustacean to orient upwardly a ventral surface of the crustacean before the crustacean exits the curvature section at a chute exit. A hollow structure is selected to connect to the chute exit and define an imaging aperture in an upper wall of the hollow structure. An imaging apparatus is selected having an optical view directable through the imaging aperture images each crustacean passing through the hollow structure. A computer informationally connected to the imaging apparatus and configured to execute a program is operated to determine, for each imaged crustacean, whether the visible characteristic is present in that imaged crustacean, to assign a first classification to that imaged crustacean based on presence or absence of the visible characteristic, and to instruct a diverter mechanism to direct crustaceans having the first classification to a different location than crustaceans lacking the classification.

### BRIEF DESCRIPTION OF THE DRAWINGS

In what follows, preferred embodiments of the invention are explained in more detail with reference to the drawings, in which:

FIG. 1 is a schematic side view of a system according to the present invention;

FIG. 2 is a bottom view showing certain portions of the system of FIG. 1;

FIG. 3 is an illustration similar to FIG. 1 to depict a typical order of events as a crab passes through the system;

FIG. 4 is an example of the type of top view that the camera sees of a crab;

FIG. 5A illustrates the target location 510 on a crab CB for selected pre-molt signs;

FIG. 5B illustrates a normal inter-molt within target 510b and FIG. 5C shows indication of pre-molt with target 510c;

FIG. 6 is a schematic side view showing alternate input and output components;

FIG. 7 is a flow chart of a determinator algorithm according to the present invention;

FIG. 8 shows a timing diagram when a crab is detected int the image and diverted;

FIG. 9 shows a timing diagram when no crab is detected in the image; and

FIG. 10 shows the general operation of a diversion from a high-pressure air nozzle.

### DETAILED DESCRIPTION OF THE PRESENTLY PREFERRED EMBODIMENTS

Systems and methods according to the present invention automatically identify one or more selected characteristics such as indications of pre-molt for crabs on the ventral side of the shell. An image is captured of the ventral side with a digital camera and then it is computationally determined from the image whether or not the crab is in a pre-molt condition. This can either be done by positioning the camera to view the crab from the underneath to view through a viewing window or, more preferably, is done by flipping the crab upside down so that the ventral side can be imaged from above.

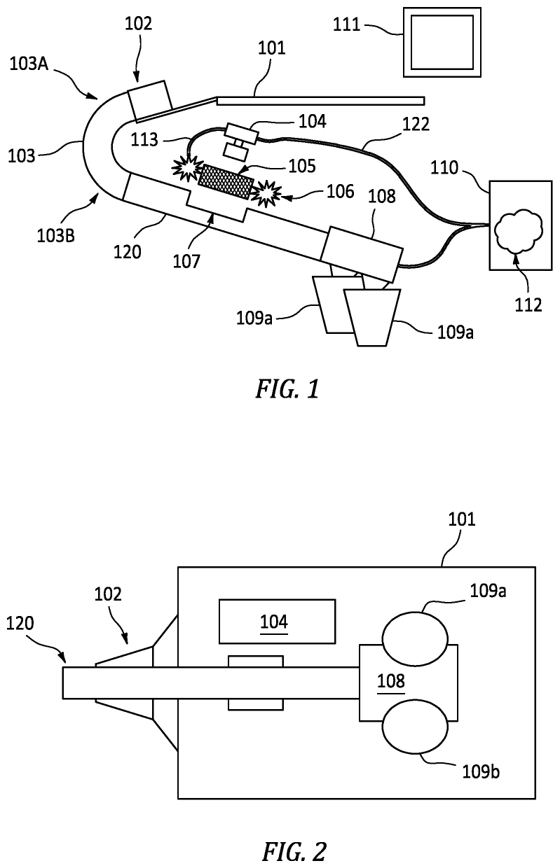

This invention may be accomplished by a curved chute, such as a “U” shaped tube 103, FIG. 1, that has a substantially rectangular cross section in one construction and that is made of a low friction material, at least on its interior surface. At the front of the tube is an input chute 102 for receiving incoming crab to be classified and sorted. A curved section of the tube has a “U”-type shape in which the sliding crab is flipped by gravity. Along the tube after the “U” is a hollow structure 120 an opening 107, also referred to herein as an imaging aperture 107 or an imaging window, so that the camera 104 can see the ventral side of the flipped crab. At the end of the tube 120 is a diversion mechanism 108 that can shift the crab into an appropriate bin 109a or 109b. A computer 110 runs a determinator algorithm 112 that receives the image data 122 from the camera 104, analyzes the image, makes an inference about what is in the image to infer a classification for the crab, and signals the diversion mechanism 108 to operate accordingly.

Live crab typically is accompanied by seawater, seaweed, and other debris so would be difficult to keep a viewing window under the crab clean enough to see details clearly. Droplets of water on the viewing window would distort any image captured from underneath. By flipping the crab and viewing from above we have the advantage of a dry clear path between the camera and the crab. Therefore, the system should flip the crab over without injuring it and provide a view to a camera of the ventral side of the crab.

Once in image of the ventral side is captured the system needs to make a determination, based on one or more visually-perceptible characteristics, of whether or not the crab is in the pre-molt condition. The system enhances visual recognition of selected characteristics such as pre-molt signs on the ventral surface of each crustacean; the system has the computational ability and image analysis algorithms required to achieve this determination. In certain constructions, the crabs need to be divided into at least two categories. The system should have a diversion mechanism that can guide a crab into the appropriate bin depending on the determination.

The term “portion” or “leg” as utilized herein refers to a section or region of a component, without necessarily indicating any physical difference between two or more portions or legs apart from location such as “upper portion”, “upper leg”, and “lower portion”, “lower leg”.

The term “substantially” as utilized herein encompasses deviations of up to ten percent, such as “substantially rectangular cross-section” encompassing deviations up to ten degrees from each other, such as walls of the substantially rectangular tube forming angles ranging from 80 degrees to 100 degrees.

A curved, typically “U” shaped tube 103 is illustrated in FIG. 1. A selected crustacean such as a crab is flipped with minimal risk of injury when passing through the tube, which has an upper leg 103A and a lower leg 103B; the term “leg” is utilized herein as a synonym for “portion”, “segment” or “section”. In a manually loaded embodiment, the tube is mounted such that the upper leg of the “U” is attached to a chute 102 which is in turn attached to the edge of a table 101.

The table preferably is positioned at an ergonomic height that allows the user to reach the complete surface of the table when standing. The table is large enough to hold a bushel or so of crab coming from a trap or carrying bag. For manual operation a load of crab is emptied on the table and then each crab is slid manually into the chute 102.

The tube has an interior, substantially rectangular cross section of approximately 2″×3″ and is made of a material like HDPE (high-density polypropylene), PVC (polyvinyl chloride), stainless steel, or aluminium that has low friction when dry or wet. The cross section of the tube is large enough to allow all anticipated crab sizes to pass smoothly yet small enough to restrict the crab from flipping itself unexpectedly in the tube. Each of the legs of the tube is mounted with sufficient incline that a crab can reliably slide completely through using gravity alone. For this reason, the legs of the U-shaped tube diverge and are not parallel. Experimental results indicate that an angle of about 11 degrees is reasonable for this incline.

In the normal embodiment the lower leg of the tube 103B terminates in a diversion mechanism that is used to send the crab into one bin or another. There is an aperture 107 in the top of this lower leg so that a camera mounted above can look into the tube and see what is going by.

A crab that is inserted into the chute 102 at the top leg of the “U” slides towards the bend. As the crab falls through the bend in the tube it gets flipped so that the crab is sliding on its carapace as it goes through the bottom leg of the tube 103B.

The camera 104 that looks down into the aperture 107 in the lower leg of the “U” is capable of rapidly taking images at a rate of 30 per second or greater.

The determinator algorithm receives each image from the camera. Most images are of the empty tube, but when a crab goes by the change is noticed and the image is treated differently. First a quick check is performed to confirm whether or not a crab is centered in the image. If not then it quickly resets and prepares for the next image.

The image with the crab is passed to the inference algorithm to be analyzed to check for signs of a pre-molt condition. If the sign is present then the status is recorded so that the diverter can be actuated when the crab goes past. Otherwise the crab goes into the intermolt bin.

The purpose of the inference algorithm is to determine what classes of objects are visible in the image. In this case there are 4 main class options to cover the combinations of male/female and premolt/intermolt. There may be more options in the future to cover other attributes of the crab that are interesting.

The inference algorithm can be implemented with a machine learning technique using a Convolutional Neural Net (CNN). One widely used CNN model is called YOLO. Alternately, portions can be implemented at a lower level with Support Vector Machines (SVM) and explicit custom written computer code.

The visible signals of premolt can be subtle. The illumination must be sufficiently even and/or diffuse that features of the crab are not confused with shadows and hot spots caused by directional lighting. Imaging practitioners sometimes refer to this general style as “cloudy day” illumination. This can be achieved either by passing light through frosted glass type diffusers or by reflecting light off of a matte white surface. In either case the light envelope should surround the subject as completely and evenly as possible.

In preferred constructions, the crab is constantly moving through the tube as it passes under the camera. There are two basic options for adequately limiting the blur in the image that would be caused by the motion of the crab. The light can be strobed in a pulse for every image or the camera can expose each image for a short duration. For instance, if the crab is moving at 1000 mm/s and the desired resolution is 0.1 mm then the resulting light pulse or exposure period needs to be less than 0.1 ms ( 1/1000×0.1). In this duration enough light needs to get to the camera sensor in order to produce a quality image.

At the beginning of the tube is a V shaped chute 102 that has a large end that is big enough to allow crabs to be easily inserted in any orientation. The small end is the same size as the cross section of the flipping tube. As the crab goes into the chute it generally crawls towards the tube becomes oriented such that it goes into the tube sideways. It slides in legs first so that it is facing the side of the tube.

The flipping tube 103 is curved such that the crab starts to rotate as it falls into the arc and then completes the rotation as its dorsal surface hits the far side of the tube and slips down. By the time the crab exits the arc it is sliding on its carapace. The crab then slides past the imaging aperture 107 where it becomes visible to the camera. The crab then continues on to the diversion mechanism 108 where it is directed into the appropriate bin 109.

The velocity of the crab can be determined by measuring the position of the crab in sequential images and dividing the distance traveled by the difference between the times that the two images were captured. This velocity is useful in estimating when the crab will reach the diversion mechanism.

The important parts for image capture are the camera 104, the lights 106, and the diffuser 105. The camera is mounted in a watertight case with a clear imaging window that can be easily cleaned. It looks down through a hole in the diffuser and through the imaging aperture in the tube. The purpose of the diffuser is to achieve even “cloudy day” illumination. The lights are typically white light emitting diodes (LEDs) that are positioned so that they illuminate the diffuser and do not shine directly on the crab. If the lights are not strobed then they are kept at an intensity high enough that the camera exposure can be sufficiently short to mitigate blur. An optional strobe signal 113 goes from the camera to the driver circuit of the lights. It is used when the lights are strobed.

The diffuser 105 is a sheet of translucent or opaque material that is curved over the view aperture. A hole in the diffuser allows the camera to view through it. The lights either shine up at the diffuser from underneath or down from behind the diffuser.

The computer 110 is connected to the camera 104, the diverter 108, and the user display 111. The main program running on the computer is referred to as the “determinator” 112. This program receives and analyzes images from the camera, runs an inference algorithm on those images, and produces signals to the diverter. A waterproof touch screen monitor acts as the user display and is used to present options to the user and allows the user to set values and choose configurations.

The bottom view of FIG. 2 shows the basic position of the tube as it curves down and back under the table towards the bins. The tube is roughly centered along the table from front to back.

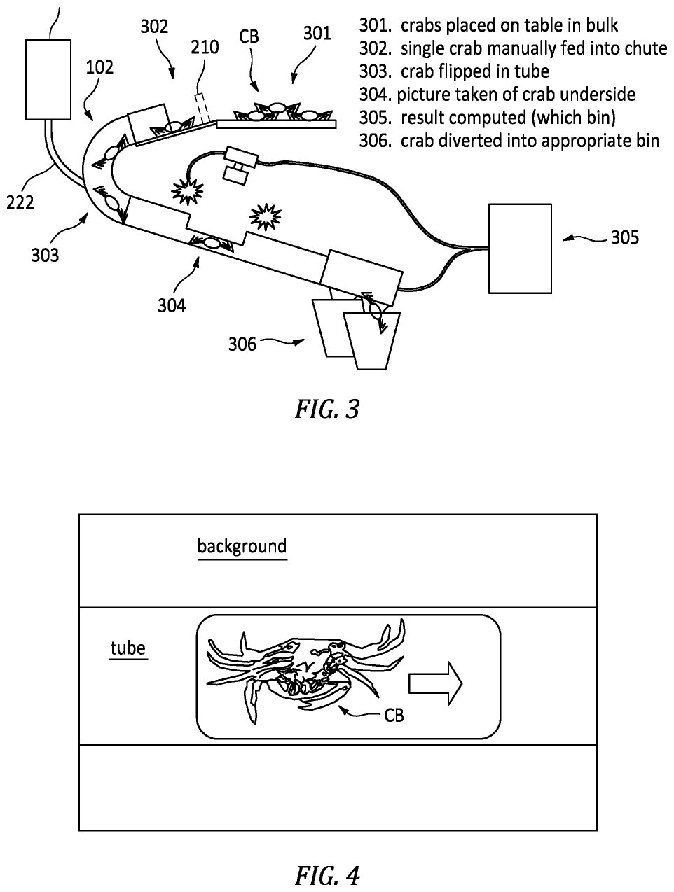

The action sequence of FIG. 3 illustrates the sequence of handling a single crab by showing the crab positions. In step 301 the crab CB emptied from bag or trap onto the table. In step 302 a single crab is fed into the chute. In step 303 the crab is flipped by the arc of the tube. In step 304 a picture is taken with the crab in the field of view. In step 305 the inference is performed and the appropriate bin is determined. In step 306 the crab is diverted into the bin by a signal from the computer to the diversion mechanism.

Optional gate 210 is indicated in phantom in FIG. 3. Optional water source 220 is fluidly connected to water feed 222 to provide a “trickle” of seawater to enhance transit of crabs and purge debris from the tube.

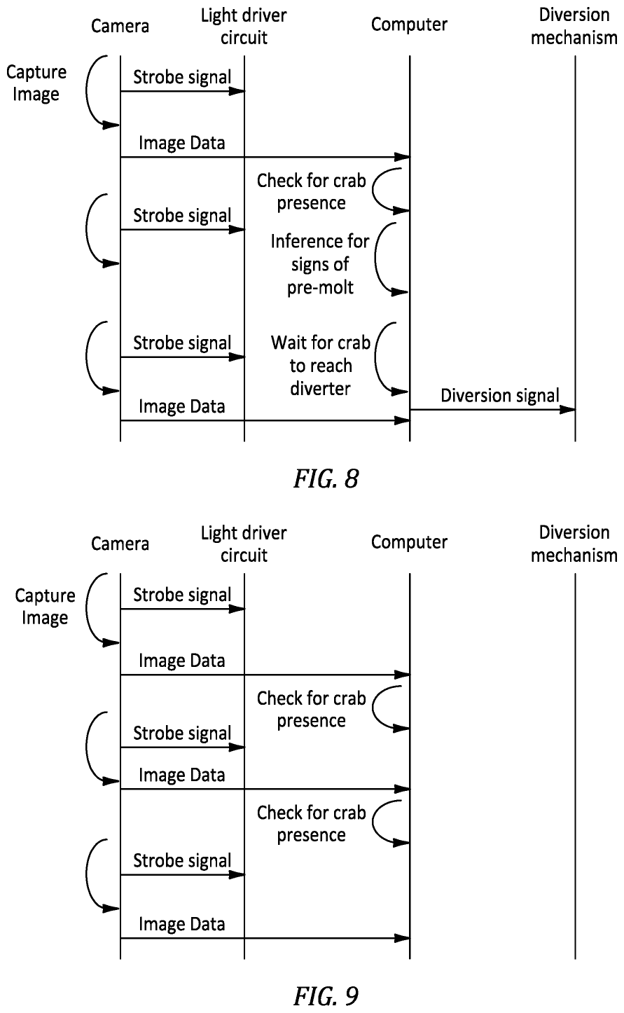

The timing of crab analysis sequence using a strobed light is shown in FIG. 8. In this case the camera sends a strobe signal to the LED driver sometime in each exposure. When the image capture is complete the image is sent from the camera to the computer. The determinator algorithm starts to work on the image first by checking for the crab presence and then (if the crab was detected) continuing to do the inference to look for signs of pre-molt. If a diversion is needed then the condition is queued until the time when the crab passes to the diversion mechanism and the diversion mechanism is activated.

The timing when the camera is free running and no crab is detected is shown in FIG. 9. In this case we can see that the determinator algorithm checks for crab presence in each image but does not continue on with the inference. This is done at the frame rate of the camera (30 Hz or greater).

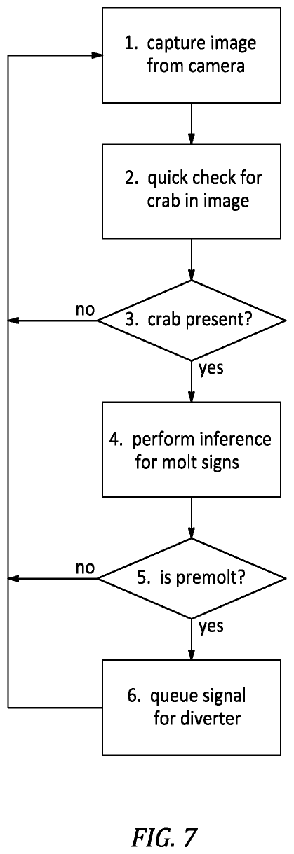

A flowchart representation of the determinator algorithm is shown in FIG. 7. There are two main decision points in the algorithm. The first decision is about whether to do the inference and the second decision is whether to divert the crab.

The crab presence detection is performed by subtracting the current image from a previous image of an empty and looking for differences. This can be done very quickly with minimal computation. If the quick check determines that a crab is present, then the algorithm proceeds to continue on to do the inference to detect pre-molt signs.

The inference that checks the image for signs of pre-molt is computationally intensive, but it must be completed before the crab reaches the diversion mechanism. The tube section between the aperture and diverter must be long enough and the algorithm implementation fast enough to achieve this.

One way to improve the needed computational speed is through the use of special types of processors like a Graphical Processing Unit (GPU) or a Tensorflow Processing Unit (TPU). Another way is to break up the task to run on multiple cores of the Central Processing Unit (CPU).

An example of the general layout of a typical camera image is shown in FIG. 4. The camera sees the tube that the crab CB is sliding in and when a crab goes by the aperture the camera sees the crab in the aperture. Each crab has a different rotation about the dorsal-ventral axis, but generally the left-right axis of the crab is within 30 degrees of a line along the tube. The inference algorithm must handle this variation rotation from crab to crab.

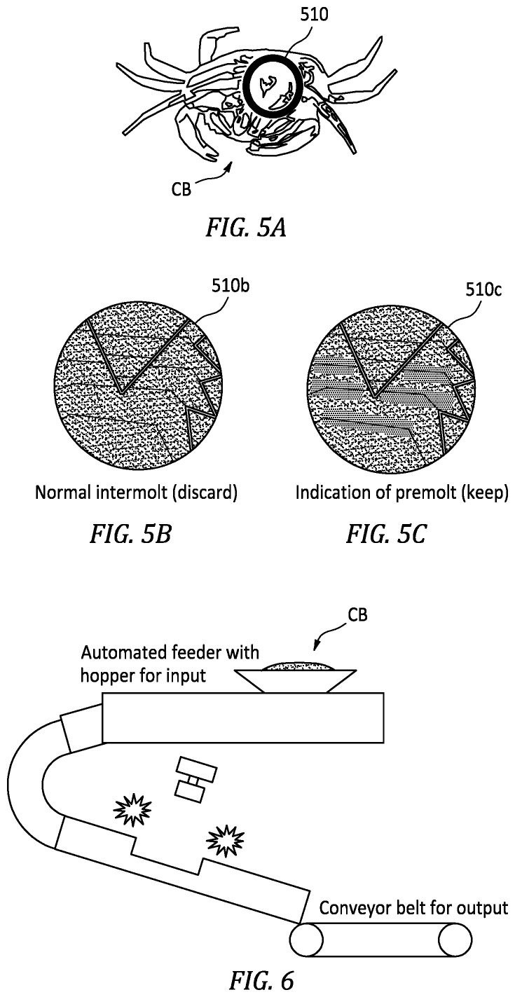

The general location where the pre-molt signs show up on the ventral surface of a green crab are shown in FIGS. 5A-5C. The inference algorithm targets this general location 510 for its analysis. These are the same locations that skilled fishers look at to identify pre-molt crab. The key locations to look at are the edges of the sections of the thorax that contain the leg muscles. FIG. 5B illustrates a normal inter-molt within target 510b, resulting in a discard command, while FIG. 5C shows indication of pre-molt with target 510c, resulting in diversion to a keeper bin.

Options to support a more automated and larger-capacity version of the apparatus are shown in FIG. 6. On the input side, a device is shown that includes a hopper and feeder. The hopper is capable of handling a bulk deposit of crustaceans. The feeder is capable of automatically singling crustaceans and inserting them into the chute and/or tube. On the output side, a conveyor can be utilized to move the product to a different location or height in a packing facility before the selected crustaceans are handled based on the established classification. For examples of known conveyors, see, for example, U.S. Pat. No. 11,001,452 B2 by Shaw et al. for conveyor apparatus with imaging for food products.

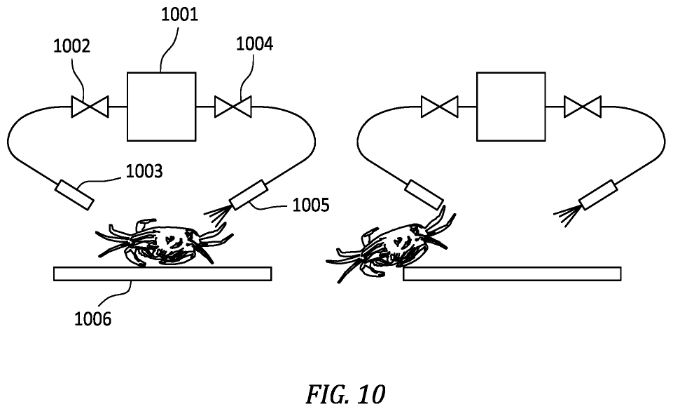

The basic operation of a pneumatic diversion using pressurized air is shown in FIG. 10. This is a cross section where the crab is moving out of the page. The tube cross section would be behind the crab but it is not shown.

In this case the right valve 1004 is opened so that air from the pressurized air source 1001 goes out the right nozzle 1005 and pushes the crab off the diversion platform 1006 in the left direction into the bin that sits on that side. The timing is coordinated so that the air valve is opened just as the crab is sliding down that section of the platform.

Certain embodiments of the present invention have been described above in terms of green crabs, but that is not a limitation of the invention. The ventral surface of other types of crustaceans can be imaged for one or more selected characteristics, such as determining the sex of a lobster by comparing its swimmerets to determine if the imaged lobster is male or female.

Although specific features of the present invention are shown in some drawings and not in others, this is for convenience only, as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is to be understood that the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions. Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on, or executable by, a programmable computer including any combination of any number of the following: a processor, a storage medium readable and/or writable by the processor (including, for example, volatile and non-volatile memory and/or storage elements), an input device, and an output device. The input device and/or the output device form a user interface in some embodiments. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention automatically and rapidly identify selected characteristics visually, automatically update data in an electronic memory representing such recognized characteristics, and automatically operate a diverter mechanism to rapidly sort crustaceans for storage and processing. Such features can only be performed by computers and other machines and cannot be performed manually or mentally by humans.

Any claims herein which affirmatively require a computer, a processor, a controller, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a controller, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays).

A computer can generally also receive (read) programs and data from, and write (store) programs and data to, a non-transitory computer-readable storage medium such as an internal disk (not shown) or a removable disk or flash memory. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium or other type of user interface. Any data disclosed herein may be implemented, for example, in one or more data structures tangibly stored on a non-transitory computer-readable medium. Embodiments of the invention may store such data in such data structure(s) and read such data from such data structure(s).

It is the intention, therefore, to be limited only as indicated by the scope of the claims appended hereto. Other embodiments will occur to those skilled in the art after reviewing the present disclosure and are within the following claims.

What is claimed is:

1. A system to classify and manipulate a selected species of crustacean based on at least one selected characteristic visible on a ventral side of the crustacean, comprising:
a curved chute selected to have an inner diameter at least as large as an average maximum dimension of the selected species, the chute defining an opening to receive at least one crustacean at a time, and the chute having a curvature of a curvature section sufficient to invert the crustacean to orient upwardly a ventral surface of the crustacean before the crustacean exits the curvature section at a chute exit;
a hollow structure connected to the chute exit and defining an imaging aperture in an upper wall of the hollow structure;
an imaging apparatus having an optical view directable through the imaging aperture to image each crustacean passing through the hollow structure; and
a computer informationally connected to the imaging apparatus and configured to execute a program to determine, for each imaged crustacean, whether the visible characteristic is present in that imaged crustacean, to assign a first classification to that imaged crustacean based on presence or absence of the visible characteristic, and to instruct a diverter mechanism to direct crustaceans having the first classification to a different location than crustaceans lacking the classification.

2. The system of claim 1 wherein the curved chute is configured to invert each crustacean without physically injuring the crustaceans.

3. The system of claim 1 further including the diverter mechanism, and wherein the diverter mechanism utilizes pressurized fluid to divert selected crustaceans without physically injuring the crustaceans.

4. The system of claim 3 wherein the diverter mechanism utilizes pressurized air to divert the crustaceans without injury.

5. The system of claim 1 wherein the imaging apparatus includes at least one camera and at least one source of illumination.

6. The system of claim 1 wherein at least one of the curved chute and/or the hollow structure is tubular in cross-section.

7. The system of claim 1 wherein the curved chute and the hollow structure are monolithic.

8. The system of claim 1 wherein at least the curved chute has a low-friction interior surface which does not noticeably impede travel of each crustacean over the interior surface.

9. The system of claim 1 wherein the selected species is a type of crab and the curved chute is selected to have an inner diameter at least as large as an average width of a carapace of that species of crab.

10. The system of claim 1 wherein the computer utilizes a machine learning algorithm to determine presence or absence of the first classification per crustacean.

11. The system of claim 1 wherein the first classification is based on molt phase of the selected crustacean.

12. The system of claim 1 wherein the first classification is based on at least one of gender, size and/or color of the selected crustacean.

13. The system of claim 1 wherein presence of each crustacean traveling past the imaging aperture is detected from camera images without need for an additional trigger sensor.

14. The system of claim 1 further including an inlet for a stream of water to assist transit of the crustacean and to physically move debris through at least the hollow structure.

15. A method of classifying and manipulating a selected species of crustacean based on at least one selected characteristic visible on a ventral side of the crustacean, comprising:
selecting a curved chute having an inner diameter at least as large as an average maximum dimension of the selected species, the chute defining an opening to receive at least one crustacean at a time, and the chute having a curvature of a curvature section sufficient to invert the crustacean to orient upwardly a ventral surface of the crustacean before the crustacean exits the curvature section at a chute exit;
selecting a hollow structure connected to the chute exit and defining an imaging aperture in an upper wall of the hollow structure;
selecting an imaging apparatus having an optical view directable through the imaging aperture to image each crustacean passing through the hollow structure;
and operating a computer informationally connected to the imaging apparatus and configured to execute a program to determine, for each imaged crustacean, whether the visually-perceptible characteristic is present in that imaged crustacean, to assign a first classification to that imaged crustacean based on presence or absence of the visible characteristic, and to instruct a diverter mechanism to direct crustaceans having the classification to a different location than crustaceans lacking the first classification.
